(19) United States
(12) Patent Application Publication
(10) Pub. No.: US 2008/0151307 A1
(43) Pub. Date: Jun. 26, 2008

(54) PRINT PROCESSING DEVICE AND PRINT PROCESSING METHOD

(75) Inventors: Katsuhiro Minamida, Yokohama-shi (JP); Atsushi Torisaki, Yokohama-shi (JP); Hirotsugu Matsumoto, Tokyo (JP); Hideaki Kurihara, Tokyo (JP); Takeshi Ooyama, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/949,237

(22) Filed: Dec. 3, 2007

(30) Foreign Application Priority Data
Dec. 21, 2006 (JP) 2006-344392

(51) Int. Cl. G06K 15/00

(52) U.S. Cl. 358/3.24

(57) ABSTRACT

A print processing device comprises: a storage to store an input print job including image data of plural pages; a print processor to perform printing to plural papers based on the image data of the plural pages; an image reader to acquire the image data for each page of the plural printed papers; a determiner to determine whether a print state for each page is good or bad, by comparing the acquired image data for each page with stored corresponding image data; and a controller to control, if the print state for a specific page is bad, the print processor to perform reprinting based on the image data of the specific page and the image reader to stand by for reading of a subsequent page until the reprinting ends, thereby enabling to easily replace, in the reprinting for a page of bad print state, this page with the reprinted page.

### BACKGROUND OF THE INVENTION

1. Field of the Invention

The present invention relates to a print processing device and a print processing method.

2. Description of the Related Art

Conventionally, a technique of determining whether or not a print processing state of a printed material is good has been widely known.

For example, in Japanese Patent Application Laid-Open No. H10-145530 (hereinafter, called a patent document 1), an image which has been printed on a paper is read by an image reading device such as a linear image sensor or the like, the read image is converted into electronic data, and electronic data of an original image printed on the paper and the read and converted electronic data are checked (or compared) with each other to determine whether a print processing state of the relevant image is good or no good (bad). Then, if it is determined that the print processing state of the original image is no good (bad), the relevant image is reprinted on a paper.

In the patent document 1, plural papers on which the images corresponding to plural pages have been printed respectively are read by the image reading device, the read image of each page is converted into the image data, and the acquired image data is checked with that of the original image. In such a method, a user of the image reading device has to replace the paper read and determined that it is in a no-good print processing state by the image reading device with a corresponding paper to which reprinting to solve the relevant state has been performed.

For this reason, it is cumbersome for the user to perform such a replacing process (or a paper inserting process). Also, there is a possibility that a human error occurs in the process because it is complicated.

Besides, in the patent document 1, since the image data of the original images are checked with the read image data after all the plural papers were read by the image reading device, there is a problem that, if a memory capacity for storing the read image data is small, it is impossible to cope with a printed matter which includes a large number of pages.

### SUMMARY OF THE INVENTION

The present invention has been achieved in consideration of such conventional problems as described above, and the present invention aims to provide an improved print processing device and an improved print processing method.

Further, the present invention aims to provide a print processing device and a print processing method which can cause a user of the print processing device to easily replace, in case of producing a superior printed material by performing a reprint process for a page of which a print processing state is no good, a paper of the page of which the print processing state is no good with a paper to which the reprint process has been performed.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate numerous embodiments, feature and aspects of the present invention and, together with the description, serve to explain the principles of the invention.

FIG. 1 is a block diagram for describing the constitution of an image processing system according to a first embodiment.

FIGS. 2A and 2B are schematic block diagrams for respectively describing an image inspection process and an image complementing process to be performed by an MFP (multifunction peripheral) illustrated in FIG. 1.

FIG. 3 is a cross section diagram illustrating the constitution of a paper discharge unit having an inserter capable of being connected to a printer unit illustrated in FIG. 1.

FIG. 4 is a diagram illustrating the configuration of a software module running on the MFP illustrated in FIG. 1.

FIG. 5 is a diagram illustrating an example of a print setting screen provided by a printer driver installed in an HD (hard disk) of a PC (personal computer) illustrated in FIG. 1.

FIG. 6 is a diagram illustrating an example of an operation panel illustrated in FIG. 1.

FIG. 7 is a diagram illustrating an example of messages to be displayed on an LCD (liquid crystal display) touch panel illustrated in FIG. 6.

FIG. 8 is a flow chart indicating an example of a first data processing procedure in a print processing device.

FIG. 9 is a flow chart indicating an example of a second data processing procedure in the print processing device.

FIG. 10 is a flow chart indicating an example of a third data processing procedure in the print processing device.

FIG. 11 is a diagram illustrating an example of voice guidance to be voice-output from a voice output unit provided on the operation panel of the MFP illustrated in FIG. 1.

FIG. 12 is a flow chart indicating an example of a fourth data processing procedure in the print processing device.

FIG. 13 is a diagram for describing a memory map of a storage medium which stores various kinds of data processing programs capable of being read by the print processing device.

### DESCRIPTION OF THE EMBODIMENTS

The present invention will now be described in detail with reference to the drawings showing various exemplary embodiments thereof. In the drawings, elements and parts which are identical throughout the views are designated by identical reference numerals, and duplicate description thereof will be omitted.

Subsequently, the exemplary embodiments for carrying out the present invention will be described with reference to the attached drawings.

<Description of System Constitution>

### First Embodiment

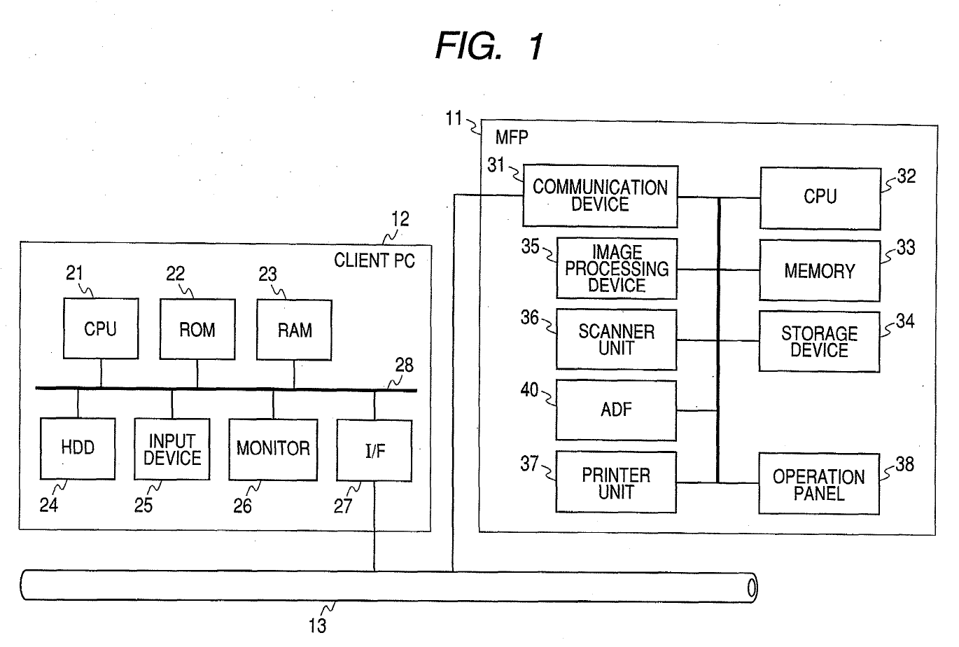

FIG. 1 is a block diagram for describing the constitution of an image processing system (print processing system) according to the first embodiment. The present embodiment is equivalent to an example of the image processing system in which a client PC 12 and an MFP 11 perform an image process (print process) through a network 13.

In the client PC 12 illustrated in FIG. 1, a CPU 21 directly or indirectly controls respective devices mutually connected through an internal bus 28 to perform programs for achieving the operations of the client PC 12, such as a process of creating and transmitting a print job to the MFP 11. Here, it should be noted that the respective devices include a ROM 22, a RAM 23 and the like (all described later).

The ROM 22 stores therein basic software including the BIOS (Basic Input/Output System) and the like, and the RAM 23 is used as a working area for the CPU 21.

Further, data are temporarily stored in the RAM 23 to load application programs, and the programs are stored as files in an HDD (hard disk drive) 24.

An input device 25 acts as a user interface. For example, when an operation screen selected from among the programs is displayed on a monitor 26, the input device 25 is used to input data based on user's operations in regard to the displayed operation screen. That is, the monitor 26 displays the operation screen and other screens. An I/F (interface) 27 is used to mutually connect the client PC 12 and the network 13 with each other.

Subsequently, in FIG. 1, the MFP 11, which is a network-applicable MFP, provides to a computer terminal various services such as a print service, a scanning service, a storage service, a transmission service and the like. Here, it should be noted that the transmission service includes facsimile transmission, E-mail transmission, file transmission and the like.

For example, the MFP 11 includes a communication device 31, a CPU 32, a memory 33, a storage device 34, an image processing device 35, a scanner unit 36, a printer unit 37, and an operation panel 38.

The CPU 32 performs programs for achieving various kinds of functions in the image processing device 35.

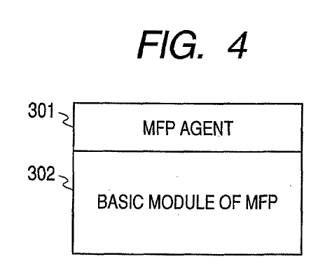

More specifically, the CPU 32 reads an MFP agent 301 (FIG. 4) from the storage device 34. Here, it should be noted that the MFP agent 301 is a program for achieving the operations of the MFP 11 in the first embodiment. Then, the CPU 32 performs the read program (MFP agent 301) by using the memory 33 as a working area. The operation panel 38, which acts as a user interface, includes a touch panel function. An ADF (automatic document feeder) 40 separates one by one originals from a sheaf thereof put on an original table, and feeds the separated original onto a platen of the scanner unit 36 provided in the MFP 11. Subsequently, an image of the original put on the platen is read by an optical scanning unit of the scanner unit 36, and the original is then discharged from the platen to a paper discharge tray on the ADF 40 which is the paper discharge destination.

Here, there is a case where the sheaf of the origins put on the ADF 40 is output papers print-processed by the printer unit 37. That is, as described later, if a print processing state of a specific page print-processed by the printer unit 37 is determined in an image process, feeding of the print-processed papers is controlled. In the present embodiment, the ADF 40 is constituted to be able to perform an original feeding process to discharge to the paper discharge tray the originals which have been read by the scanner unit 36.

Further, the CPU 32 controls the ADF 40 to perform the original feeding process to feed the print-processed paper to a reading position determined based on a mode of the scanner unit 36. Furthermore, the CPU 32 controls to discharge to the paper discharge destination the paper which has been read, after reading of the print-processed paper ended by the scanner unit 36.

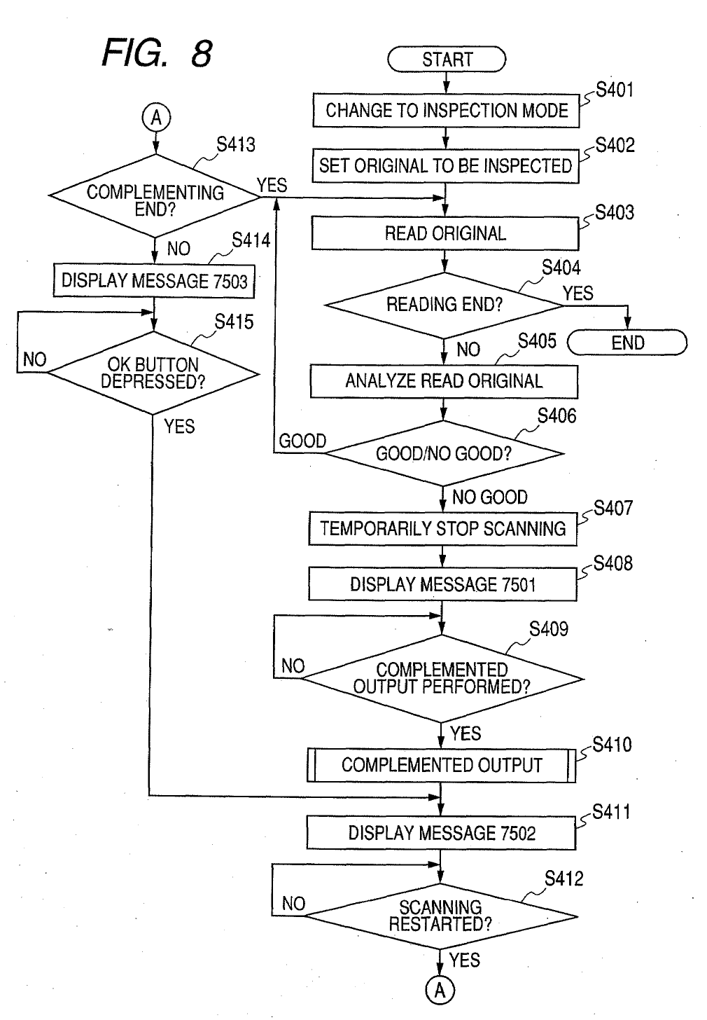

Moreover, as in a process illustrated in FIG. 8, the CPU 32 performs so-called good/no-good determination based on a result of comparison between the image on the print-processed paper and the stored image of the corresponding page. That is, the CPU 32 determines whether the image data of a specific page is good or no good (bad). Then, if it is determined that the image of the print-processed paper of the specific page is no good, the CPU 32 controls to stand by for feeding of the next print-processed paper from the ADF 40 until reprinting to the page which has been determined as the no-good page by the printer unit 37 ends.

Incidentally, the original reading is performed in either a feeding mode or a normal mode. More specifically, in the feeding mode, the optical scanning unit of the scanner unit 36 stops at a predetermined position, an exposure lamp is turned on, and images of sequentially fed originals are read. On the other hand, in the normal mode, while the original fed from the ADF 40 is being put on the platen, the optical scanning unit of the scanner unit 36 moves by itself to read the original. It is assumed that, in the present embodiment, an image inspection process is performed in the feeding mode.

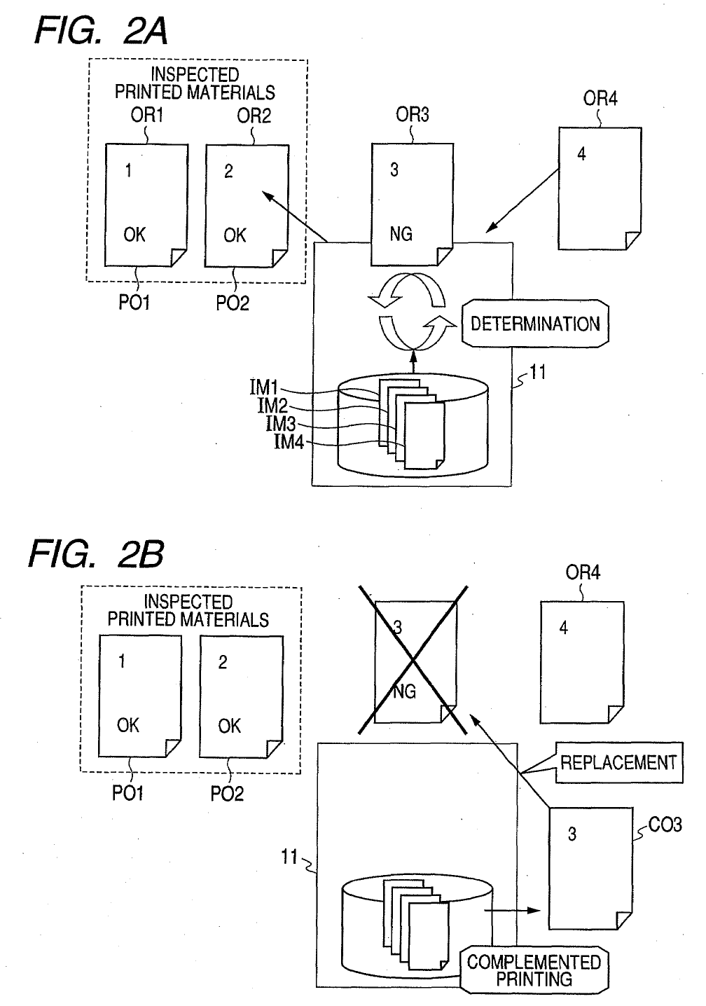

FIGS. 2A and 2B are schematic block diagrams for respectively describing the image inspection process and an image complementing process to be performed by the MFP 11 illustrated in FIG. 1. More specifically, FIG. 2A illustrates the image inspection process, and FIG. 2B illustrates the image complementing process.

FIGS. 2A and 2B are the diagrams for describing an example that the image inspection process and the image complementing process are performed by using the MFP 11 as a print processing device and an image inspection device. More specifically, in FIG. 2A, the image data of plural pages (image data IM1 to IM4 of four pages) are stored in the storage device 34 of the MFP 11, and originals OR1 to OR4 which are to be inspected and have been print-processed respectively based on the image data IM1 to IM4 are subjected to the image inspection process. Here, it should be noted that the image data IM1 to IM4 are acquired by converting, with the CPU 32, the print job transmitted from the client PC 12 to the communication device 31 of the MFP 11 into the data having a format (e.g., bitmap format) capable of being printed by the printer unit 37. In the following, the originals OR1 to OR4 will be respectively called the inspection target originals OR1 to OR4, depending on the circumstances.

The print job received from the client PC 12 is converted by the CPU 32, thereby acquiring the image data. Then, the acquired image data are print-processed by the printer unit 37, and the acquired printed materials are the inspection target originals OR1 to OR4. Then, the acquired printed material is put on the original table of the ADF 40 as the inspection target of which the print processing state is to be determined.

Subsequently, each of the inspection target originals OR1 to OR4 read as the image data for each page by the scanner unit 36 is compared with the corresponding one of the images respectively represented by the image data IM1 to IM4 generated from the inspection target print job stored in, e.g., the storage device 34. Then, the CPU 32 determines, by performing the control program, whether or not the print processing state of each of the inspection target originals OR1 to OR4 is no good (abnormal).

Here, for example, if the CPU 32 compares the inspection target original OR3 with the image data IM3 stored in correspondence with this original and determines that the print processing state of the inspection target original OR3 is no good (abnormal), the CPU 32 temporarily stops the reading operation by the scanner unit 36 and stands by for the reading of the inspection target original OR4.

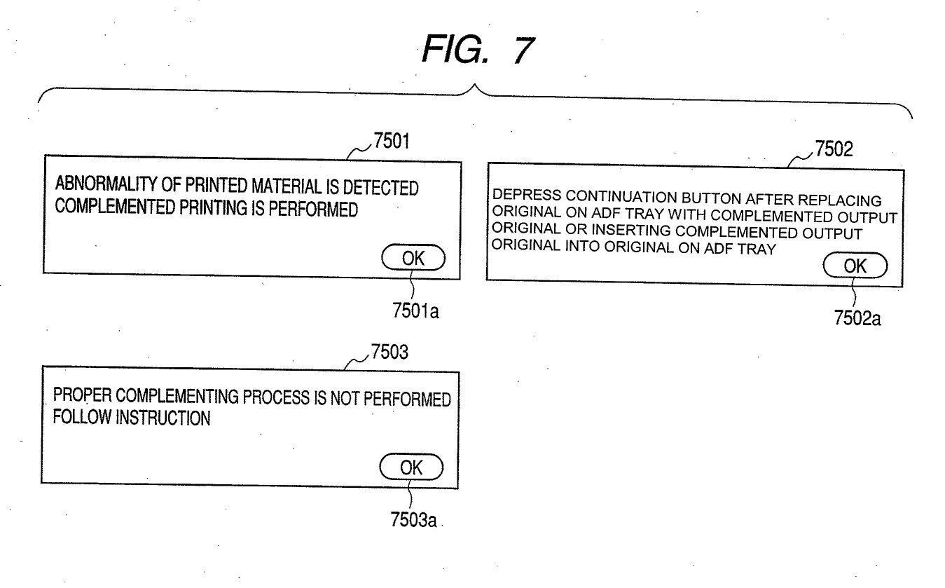

Then, as illustrated in FIG. 2B, the CPU 32 identifies, in the print job being the inspection target stored in the internal storage device of the MFP 11, the image data IM3 corresponding to the page which has been determined that its print processing state is no good. Subsequently, the CPU 32 instructs the printer unit 37 to perform the reprint process of the identified image data IM3. Thus, it is possible to perform a proper complementing operation such as replacement of the page of which the print processing state is no good, insertion of a missing page, or the like. At that time, the CPU 32 causes the operation panel 38 to display a message as illustrated in FIG. 7 for notifying a user that the print processing state of the inspection target original OR3 is no good. Further, the CPU 32 causes the operation panel 38 to display a message for urging the user to input an instruction for performing the reprint process based on the image data IM3 so as to create the paper to be replaced with the inspection target original OR3.

Here, it should be noted that the internal storage device includes the memory 33 and the storage device 34.

In the present embodiment, as illustrated in FIG. 2A, it is stopped to read by the scanner unit 36 the inspection target original OR4 subsequent to the inspection target original OR3 which has been determined that its print processing state is no good. That is, at the time when it is determined that the print processing state of the inspection target original OR3 is no good (abnormal), the CPU 32 causes the scanner unit 36 to stand by for reading of the subsequent inspection target original OR4.

At that time, the CPU 32 performs paper discharge control to discharge the inspection target original OR3 to a later-described paper discharge tray. Then, as illustrated in FIG. 2B, the CPU 32 acquires, from among the image data of the plural pages included in the print job stored in the storage device 34, the image data IM3 corresponding to the page which has been determined that its print processing state is no good, and instructs the printer unit 37 to perform the reprint process of the image data IM3.

That is, after inspection ended printed materials PO1 and PO2 to which the image inspection has been ended, an inspection ended printed material CO3 to which complemented printing has been performed is replaced with the inspection target original OR3 on the discharge tray of the ADF 40 by the operation of the user of the MFP 11 according to the message illustrated in FIG. 7.

Subsequently, the CPU 32 causes the scanner unit 36 to read the inspection target original OR4. Incidentally, it should be noted that the inspection ended printed materials PO1 and PO2 are respectively the same as the inspection target originals OR1 and OR2. The reason why different reference numbers are applied to the same subject matter is to clarify, for convenience of description, that the image inspection to the originals OR1 and OR2 has ended.

<Description of Image Processing Device>

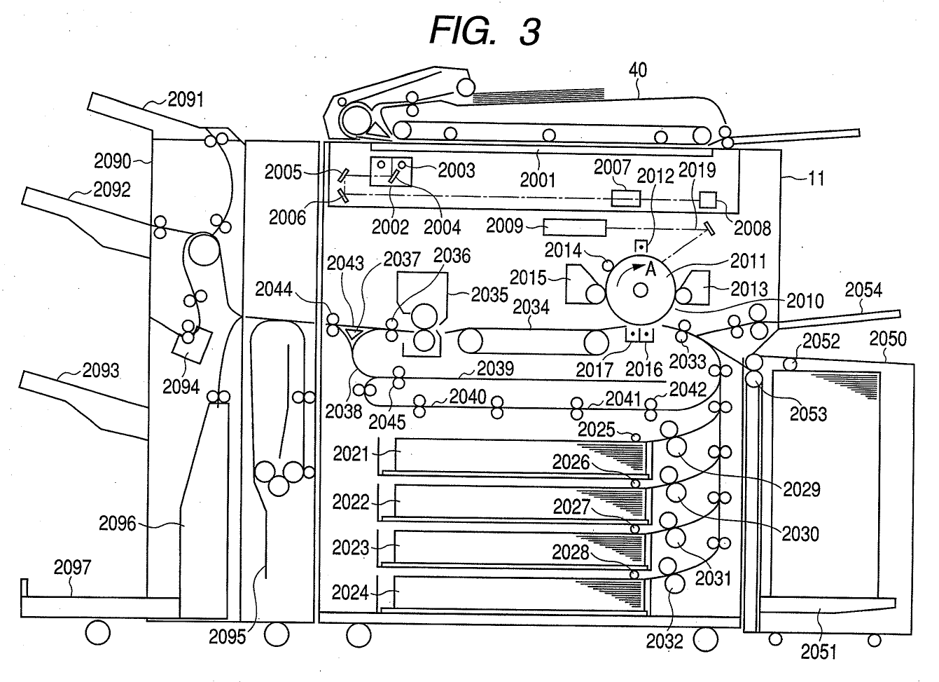

FIG. 3 is a cross section diagram illustrating the constitution of the MFP 11 illustrated in FIG. 1.

In FIG. 3, the ADF 40 feeds one by one originals from a sheaf thereof put on an original feeding table to an original table (platen glass) 2001 of the MFP 11. A scanner 2002 includes an original illumination lamp 2003, a scanning mirror 2004 and the like.

The scanner 2002 is reciprocated along a predetermined direction by a motor so as to scan the original. Reflection light from the scanned original passes a lens 2007 through scanning mirrors 2004, 2005 and 2006, and reaches a CCD image sensor (CCD) provided in an image sensor unit 2008.

The image sensor unit 2008 converts the reflection light received from the original into an electrical signal, performs a predetermined image process to the converted electrical signal, and generates an image signal based on the processed electrical signal. An exposure control unit 2009, which includes a laser generator, a polygonal scanner and the like, generates a laser beam 2019 modified based on the image signal generated by the image sensor unit 2008, and irradiates the generated laser beam 2019 onto a photosensitive drum 2011.

An image formation unit 2010 includes the photosensitive drum 2011, and a primary changer 2012, a developing unit 2013, a transfer charger 2016, a separation charger 2017, a pre-exposure lamp 2014, a cleaner 2015 and the like which are disposed in the vicinity of the photosensitive drum 2011.

In the image formation unit 2010, the photosensitive drum 2011 is driven by a motor so as to rotate in the direction indicated by an arrow A illustrated in FIG. 3. The primary charger 2012 charges the photosensitive drum 2011 up to predetermined potential. Then, the laser beam 2019 generated by the exposure control unit 2009 is irradiated on the photosensitive drum 2011 charged by the primary charger 2012, whereby an electrostatic latent image is formed thereon. Subsequently, the electrostatic latent image formed on the photosensitive drum 2011 is developed by the developing unit 2013, whereby the electrostatic latent image formed on the photosensitive drum 2011 is visualized as a toner image.

Each of a first cassette 2021, a second cassette 2022, a third cassette 2023 and a fourth cassette 2024 holds therein transfer papers used as recording media.

The transfer papers held in the first cassette 2021, the second cassette 2022, the third cassette 2023 and the fourth cassette 2024 are picked up respectively by pickup rollers 2025, 2026, 2027 and 2028. Then, the picked-up papers are transported to the MFP 11 respectively by paper feeding rollers 2029, 2030, 2031 and 2032, and the transported paper is further fed to the image formation unit 2010 by a registration roller 2033.

The transfer charger 2016 transfers the visualized toner image on the photosensitive drum 2011 to the fed transfer paper. The cleaner 2015 cleans up residual toner on the photosensitive drum 2011 after the toner image was transferred to the transfer paper. The pre-exposure lamp 2014 erases residual charges on the photosensitive drum 2011 after the residual toner was cleaned up by the cleaner 2015.

The separation charger 2017 separates, from the photosensitive drum 2011, the transfer paper on which the toner image has been transferred. A transportation belt 2034 is used to transport the transfer paper separated by the separation charger 2017 to a fixing unit 2035. The fixing unit 2035 fixes the toner image onto the transfer paper by pressing and heating the transfer paper. A discharge roller 2036 is used to discharge the transfer paper, on which the toner image has been fixed by the fixing unit 2035, outside the MFP 11.

A paper discharge flapper 2037 is used to change over a transfer path of the transfer paper to either the side of a transportation path 2038 or the side of a discharge path 2043. A lower transportation path 2040 is used to guide, to a paper re-feeding path 2041, the transfer paper transported by a reverse roller 2045 and turned over through a reverse path 2039.

A paper re-feeding roller 2042 is used to re-feed the transfer paper guided to the paper re-feeding path 2041 to the image formation unit 2010. A discharge roller 2044, which is disposed in the vicinity of the paper discharge flapper 2037, is used to discharge, outside the MFP 11, the transfer paper transported when the transfer path is changed to the side of the discharge path 2043 by the paper discharge flapper 2037.

Incidentally, in case of performing double-sided recording (double-sided copying) in the MFP 11, the paper discharge flapper 2037 is lifted. Then, the copy-processed transfer paper is guided to the paper re-feeding path 2041 through the transportation path 2038, the reverse path 2039 and the lower transportation path 2040.

At that time, the transfer paper is drawn into the reverse path 2039 up to the position of the state that the trailing edge of the transfer paper is completely released from the transportation path 2038 by the reverse roller 2045 and the transfer paper is held by the reverse roller 2045. Then, the transfer paper is transported to the lower transportation path 2040 by reversing the reverse roller 2045.

Further, in case of reversing and discharging the transfer paper from the MFP 11, the paper discharge flapper 2037 is lifted, and the transfer paper is drawn into the reverse path 2039 up to the position of the state that the trailing edge of the transfer paper still remains in the transportation path 2038 by the reverse roller 2045. Then, the transfer paper is turned over by reversing the reverse roller 2045, and the acquired transfer paper is transported to the side of the discharge roller 2044.

A paper discharge processing device (sorter) 2090 jogs the transfer papers discharged from the MFP 11 and then binds (staples) the jogged papers. More specifically, in the paper discharge processing device (sorter) 2090, the transfer papers discharged one by one from the MFP 11 are stacked and jogged on a processing tray 2094, and the sheaf of the jogged transfer papers is stapled by a not-illustrated stapler in the processing tray 2094 if discharging of the image-formed papers corresponding to one copy (one sheaf) ends. Subsequently, the acquired sheaf is discharged to a paper discharge tray 2092 or 2093.

Each of the paper discharge trays 2092 and 2093 is controlled to be moved upward and downward by a not-illustrated motor, so that each tray comes to the position corresponding to the processing tray 2094 before the image processing operation actually starts.

A dividing paper to be inserted between the discharged transfer papers is put on a paper tray 2091. A Z folder 2095 folds the discharged papers in Z-shape. A bookbinder 2096 performs bookbinding by collectively folding the sheaf of the discharged transfer papers corresponding to one copy (one volume) into two at the center thereof, and stapling the folded sheaf. Then, the bound sheaf is discharged to a discharge tray 2097.

Incidentally, the MFP 11 is equipped with a paper deck 2050 which can hold thereon, e.g., 4000 transfer papers. In the paper deck 2050, a lifter 2051 lifts according to an amount of remaining transfer papers so that a pickup roller 2052 always comes into contact with the uppermost transfer paper. The picked up transfer paper is fed to the main body of the MFP 11 by a paper feeding roller 2053. Also, the MFP 11 is equipped with a multiple manual paper feeder 2054 which can hold thereon 100 transfer papers.

Besides, the developing unit 2013 may be either a type that toner is replenished by exchanging a toner cassette or a type that toner is directly replenished into the developing unit 2013 itself. Further, the developing unit 2013 can detect an amount of residual toner.

In the present embodiment, although the constitution of a monochrome copying machine is described as an example of an image output device, a color copying machine may be used instead.

In such a case where the color copying machine is used, the developing unit 2013 includes four developing portions for yellow (Y), magenta (M), cyan (C) and black (Bk). Further, the developing unit 2013 can independently detect an amount of each of yellow (Y), magenta (M), cyan (C) and black (Bk) toners.

Besides, the MFP 11 can detect an amount of residual transfer papers held in each of the first cassette 2021, the second cassette 2022, the third cassette 2023, the fourth cassette 2024 and the paper deck 2050. Further, the paper discharge processing device (sorter) 2090 can detect an amount of residual staples held in the processing tray 2094. Furthermore, paper discharge processing device (sorter) 2090, the Z folder 2095 and the paper deck 2050 are optional devices which can be detachably set to the MFP 11.

Further, in a case where a later-described inspection job complementing mode is designated as the print job, the print job received by the MFP 11 is stored as PDL data in the storage device 34, whereby a memory capacity to be used in the storage device 34 may be small. Incidentally, there is a case where the CPU 32 determines, by comparing the image data included in the print job stored in the storage device 34 with the image data read by the scanner unit 36, that the print processing state is no good. In this case, the CPU 32 displays the message as illustrated in FIG. 7 on the operation panel 38, so that the printed material complemented by the printer unit 37 is certainly inserted into the inspected originals.

Namely, in the first embodiment, if it is determined based on the image data acquired by reading the inspection target printed material fed by the ADF 40 that the print processing state is no good, the CPU 32 notifies the user of such a fact.

More specifically, three kinds of different messages 7501, 7502 and 7503 for ending the reprint process are notified on the operation panel 38 based on a release state of the printed paper determined that the print processing state is no good and a reprint state by the printer unit 37.

Incidentally, as illustrated in FIG. 8, the CPU 32 compares the image data corresponding to the paper to be read by the scanner unit 36 with the image data corresponding to the relevant paper and stored in the storage device 34, thereby determining whether the print processing state of the inspection target printed material is good or no good.

If the CPU 32 determines that the print processing state is no good, the CPU 32 causes the scanner unit 36 to stand by for reading of a next page until the reprint process by the printer unit 37 ends.

FIG. 4 is the diagram illustrating the configuration of a software module running on the MFP illustrated in FIG. 1.

In FIG. 4, the MFP agent 301, which is a program for achieving the operation of the MFP 11 in the present invention, runs on a basic module 302 of the MFP 11. Here, it should be noted that the basic module 302 is equivalent to a module group which is a so-called controller.

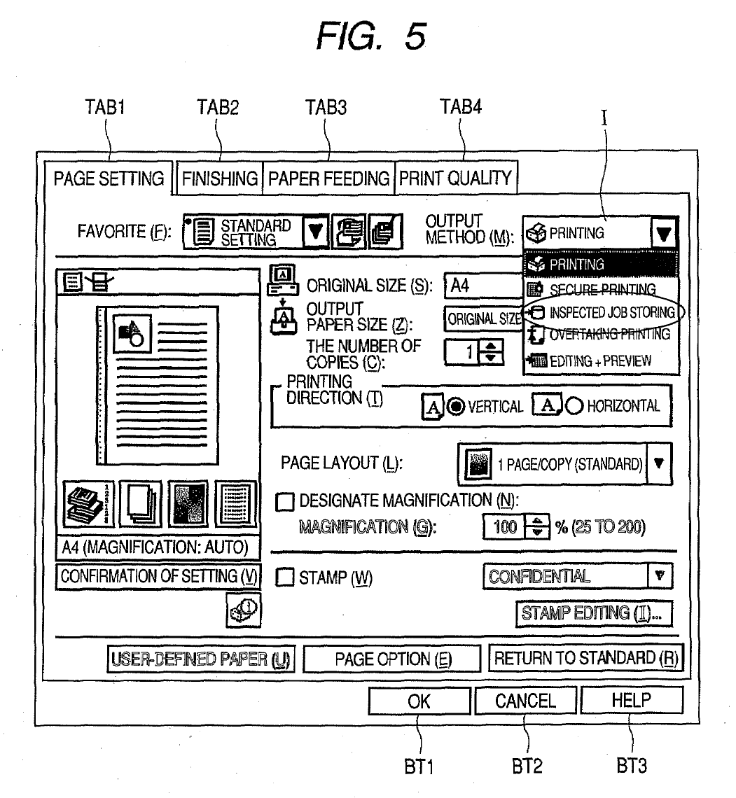

Then, in the client PC 12, to store an inspected job is designated from an item I which indicates how to output a page setting screen of the printer driver illustrated in FIG. 5.

That is, FIG. 5 is the diagram illustrating an example of s print setting screen provided by the printer driver installed in the HDD 24 of the client PC 12 illustrated in FIG. 1. In the present embodiment, for example, if printing is requested while an application is being activated, the print setting screen illustrated in FIG. 5 is displayed on the monitor 26.

On the screen illustrated in FIG. 5, if any one of tab sheets TAB1, TAB2, TAB3 and TAB4 is selected based on a user's instruction through the input device 25, it is possible to perform the print setting corresponding to the selected tab sheet.

More specifically, if the tab sheet TAB1 acting as a page setting sheet is selected, it is possible to set an output method, an original size, the number of copies, an output paper size, a print direction, a page layout, magnification designation, stamp designation, and the like.

Further, a button BT1 functions as an OK button for deciding the set contents, a button BT2 functions as a cancel button for canceling the set contents, and a button BT3 functions as a help button for showing the contents concerning the respective set items and the like.

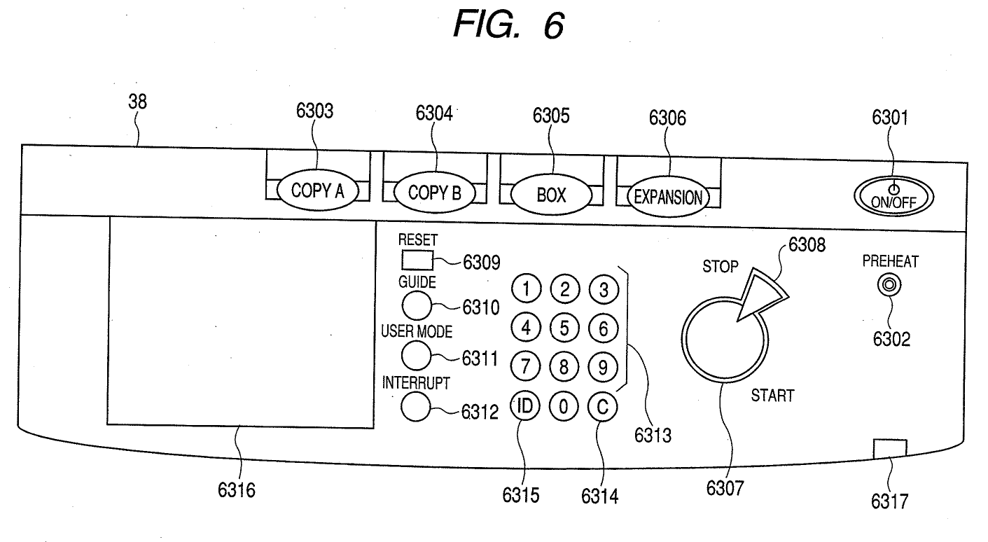

FIG. 6 is a diagram illustrating an example of the operation panel 38 illustrated in FIG. 1.

In FIG. 6, a power source switch 6301 is used to control power to be supplied to the main body of the MFP 11, a preheat key 6302 is used to turn ON/OFF a preheat mode, a copy A mode key 6303 is used to select a copy A mode from among plural functions, and a copy B mode key 6304 is used to select a copy B mode from among the plural functions. Here, it should be noted that the copy A mode and the copy B mode are essentially directed to the same copy function. However, if scanner reading in one mode ends, next copy input becomes possible in the other mode. Accordingly, to make the user understand easily, the present invention dares to provide the two kinds of copy mode keys.

A mail box key 6305 is used to select a mail box mode from among the plural functions. Here, it should be noted that the mail box function is a function to provide on the memory of the copying machine a storage area for each user or department, store PDL data and scanned images concerning the relevant user or department, and output the stored data at any time. An expansion key 6305 is used to perform an operation for the PDL data. The keys 6303 to 6306 are also used to call respective function screens on a later-described LCD touch panel 6316, whereby the user can watch and observe states of respective jobs through display on the LCD touch panel 6316.

A copy start key 6307 is used to start copying, a stop key 6308 is used to interrupt or stop copying, a reset key 6309 is used to return to a standard mode in a standby state, a guide key 6310 is used to know or confirm the detail of each function, a user mode key 6311 is used to change basic setting of the system, and an interruption key 6312 is used to interrupt other copying.

Numeric keys 6313 are used to input various numeric values, a clear key 6314 is used to clear the numeric values input by the numeric keys 6313, and an ID key 6315 is used to enter into an ID input mode when using the copying machine. The LCD touch panel 6316 includes a liquid crystal screen and touch sensors. On the LCD touch panel 6316, individual setting screen is displayed with respect to each mode, and various detailed settings can be performed by touching drawn keys. Further, the LCD touch panel 6316 displays the operations states of respective jobs. A tally lamp 6317 indicates a communication state of the network. That is, the tally lamp 6317 is being in green in ordinary circumstances, flickers in green during communication, and lights in red when a network error occurs.

FIG. 7 is the diagram illustrating an example of the messages to be displayed on the LCD touch panel 6316 illustrated in FIG. 6.

In FIG. 7, the messages 7501, 7502 and 7503 are displayed when the CPU 32 reads and determines that the print processing state of the inspection target original is no good. Then, according to the displayed messages 7501, 7501 and 7503, the user puts the replacement target paper printed by the printer unit 37 as a result of the image inspection process on the tray of the ADF 40 as the paper subsequent to the already discharged papers. Thus, it is possible to prevent that erroneously replacement occurs in case of replacing the reprinted paper with the improper paper.

Incidentally, if each of OK buttons 7501a, 7502a and 7503a is depressed to confirm and accept the corresponding message, the next message is displayed. If the OK button 7503a is finally depressed, the CPU 32 erases the message displayed on the LCD touch panel 6316 and displays the standard screen or the screen corresponding to the image inspection process.

FIG. 8 is the flow chart indicating an example of a first data processing procedure in the print processing device according to the first embodiment. More specifically, the flow chart in FIG. 8 indicates an example of the image inspection process based on the basic module 302 of the MFP 11 illustrated in FIG. 4 and includes respective steps S401 to S415. Here, the CPU 32 loads the basic module 302 from the storage device 34 to the memory 33 and performs the loaded basic module 302, thereby performing the steps S401 to S415.

Further, before performing the respective processes in the flow chart, a preprocess of storing the image inspection job in the storage device 34 of the MFP 11 is necessary.

Here, it should be noted that, in the preprocess, the client PC 12 designates, through a user interface provided by the printer driver illustrated in FIG. 5, how to output the image inspection job and whether or not to store the output as the image inspection job, and then performs the print process. Thus, if the print job is generated, the client PC 12 transmits the generated print job to the MFP 11 through the network 13, and the transmitted print job is stored as the image inspection job in the storage device 34 of the MFP 11.

On the other hand, if the client PC 12 does not yet designate, through the user interface provided by the printer driver illustrated in FIG. 5, how to output the image inspection job and whether or not to store the output as the image inspection job, the job which has been transferred and output is not stored in the storage device 34 of the MFP 11 but is discarded. As just described, the print job generated from the client PC 12 is input to the MFP 11 through the communication device 31, and the input print job is stored in the storage device 34. Here, the print job includes plural pages, and the image extracted on the memory 33 is subjected to various layout processes such as a rotation process, an enlargement process, a reduction process, a trimming process, an N-in-1 process and the like by the image processing device 35.

First, the user of the MFP 11 changes in S401 the mode to the image inspection mode through the operation panel 38, and sets in S402 the printed materials to be image inspected onto the original table of the ADF 40 of the MFP 11. Then, the CPU 32 causes in S403 the scanner unit 36 to start reading the original. Subsequently, the following operation is repeated based on the MFP agent 301 until the CPU 32 determines in S404 that reading of all the originals ends.

In S405, the CPU 32 performs the MFP agent 301 to read and analyze the originals one by one.

Here, as an example of such analysis, a method of detecting abnormality by performing pattern matching between the image data included in the image inspection job stored in the storage device 34 of the MFP 11 and the image data read by the scanner unit 36 on the memory 33 is adopted.

Subsequently, in S406, the CPU 32 determines based on the analyzed result whether the print processing state is good or no good. If the CPU 32 determines that the print processing state is good, the flow returns to the process in S403 to read a next original.

On the other hand, if abnormality of the print processing state such as rumple and/or stain of the original itself, improper printing, page missing, or the like, which occurs as the result of original feeding, is detected in S406, the CPU 32 determines that the print processing state is no good.

Then, the CPU 32 temporarily stops the original reading operation by the ADF 40 in S407, and causes the LCD touch panel 6316 of the operation panel 38 illustrated in FIG. 6 to display the message 7501 illustrated in FIG. 7 to instruct to perform complemented printing in S408.

Next, in S409, the CPU 32 determines whether or not the OK button 7501a of the message 7501 displayed on the LCD touch panel 6316 illustrated in FIG. 6 is depressed. In other words, the CPU 32 determines whether or not it is instructed by the user to perform complemented outputting with respect to the original determined that abnormality has occurred.

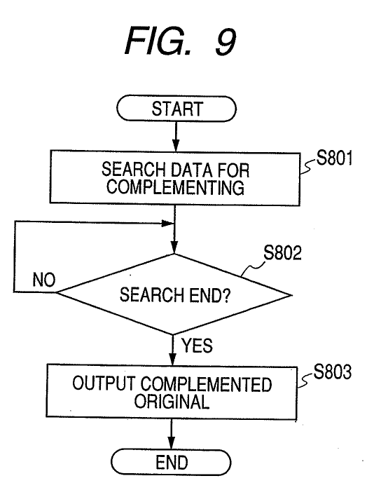

Here, if the CPU 32 determines that the OK button 7501a of the message 7501 displayed on the LCD touch panel 6316 illustrated in FIG. 6 is depressed, the CPU 32 performs a complemented output process of which the detail is illustrated in FIG. 9 (S410).

In the following, the complemented output process will be described with reference to FIG. 9.

FIG. 9 is the flow chart indicating an example of a second data processing procedure in the print processing device according to the present embodiment. More specifically, the flow chart in FIG. 9 indicates an example of the image inspection process based on the basic module 302 of the MFP 11 illustrated in FIG. 4 and includes respective steps S801 to S803. Here, the CPU 32 loads the basic module 302 from the storage device 34 to the memory 33 and performs the loaded basic module 302, thereby performing the steps S801 to S803.

In the complemented output process according to the present embodiment, in S801, the CPU 32 searches a relevant page from the job stored in the storage device 34. Next, the CPU 32 determines in S802 whether or not the search ends. If it is determined that the search ends, the CPU 32 causes the printer unit 37 to reprint only the relevant page portion, and the process ends.

As just described, if the complemented output process corresponding to S410 ends, the CPU 32 causes in S411 the operation panel 38 to display the message 7502 as illustrated in FIG. 7 to instruct the complementing operation. For example, in FIG. 5, the message 7502 is “DEPRESS CONTINUATION BUTTON AFTER REPLACING OR INSERTING COMPLEMENTED OUTPUT ORIGINAL WITH OR INTO ORIGINAL ON ADF TRAY”. Thus, the user can easily insert the complemented and output printed material into a proper position in the papers already discharged on the tray of the ADF 40, whereby it is possible to prevent conventional erroneous replacement, erroneous insertion and the like.

Next, the CPU 32 determines in S412 whether or not the continuation button 7502a of the message 7502 displayed on the LCD touch panel 6316 illustrated in FIG. 6 is depressed. In other words, the CPU 32 releases the interruption of reading of the inspection target original set on the ADF 40 and determines whether or not a restart of scanning is instructed by the scanner unit 36.

Then, if it is determined that the continuation button 7502a is depressed, the CPU 32 further determines in S413 whether or not the proper complementing operation (replacement or insertion of the original) by the user has ended.

Here, if it is determined by the CPU 32 that the proper complementing operation has ended, the flow returns to the process in S403. Thus, the CPU 32 restarts reading the inspection target original fed from the ADF 40 so as to read a next original.

On the other hand, if it is determined by the CPU 32 in S413 that the proper complementing operation does not end, that is, if it is determined by a sensor provided in the ADF 40 that the original complemented and output on the paper discharge tray of the ADF 40 is not removed yet, the flow advances to the process in S414. Then, in S414, the CPU 32 causes the LCD touch panel 6316 on the operation panel 38 illustrated in FIG. 6 to display the message 7503. Subsequently, in S415, the CPU 32 determines whether or not the OK button 7503a of the message 7503 displayed on the LCD touch panel 6316 is depressed. If it is determined that the OK button 7503a is depressed, the flow returns to the process in S411. Thus, in S411, the CPU 32 causes the LCD touch panel 6316 to display the message 7502.

Namely, if it is determined in S415 that the OK button 7503a is depressed, the LCD touch panel 6316 again displays the message 7502 to instruct the complementing operation, and such a series of processes is repeated until the proper complementing operation is performed.

In any case, according to the above-described procedure, it is possible to consistently perform the image inspection and the complementing process to the printed materials by using the scanner unit 36 and the printer unit 37 both provided in the MFP 11.

Moreover, at the time when an improper page is found in the image inspection process, the CPU 32 stops the reading operation of the scanner unit 36, and performs the implemented output. Thus, it is possible to certainly perform the replacement (or insertion) of the implemented printed material.

### Second Embodiment

The first embodiment refers to the case of consistently performing the image inspection and the complementing process to the printed materials by using the scanner unit 36 and the printer unit 37 provided in the MFP 11. In particular, in the first embodiment, if it is determined during the image inspection process that abnormality occurs, the messages illustrated in FIG. 7 are displayed on the operation panel 38 provided in the MFP 11 so as to cause the user to discard the original which has been inspected and determined that abnormality has occurred and replace the discarded original with the newly prepared original. In addition, it further causes the user to inset the paper reprinted from the job into the corresponding portion in the printed papers or to replace the corresponding portion with the reprint-processed paper.

On the other hand, it is possible to control the print processing device to output, instead of the above message, voice guidance from a speaker so as to cause the user to perform the above-described operations. In the following, the second embodiment of the present invention will be described.

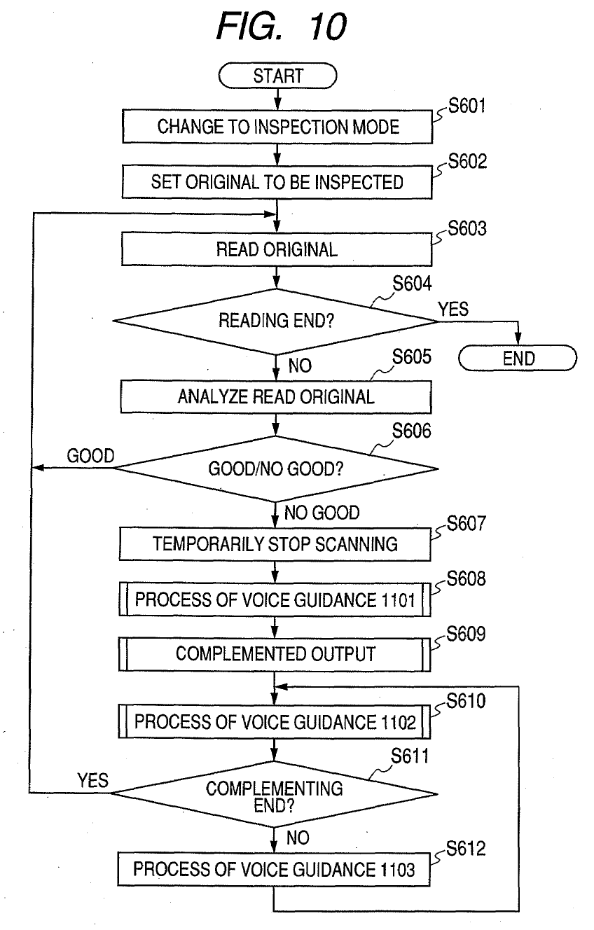

FIG. 10 is a flow chart indicating an example of a third data processing procedure in the print processing device according to the second embodiment. More specifically, the flow chart in FIG. 10 indicates an example of the image inspection process based on the basic module 302 of the MFP 11 illustrated in FIG. 4 and includes respective steps S601 to S612. Here, the CPU 32 loads the basic module 302 from the storage device 34 to the memory 33 and performs the loaded basic module 302, thereby performing the steps S601 to S612.

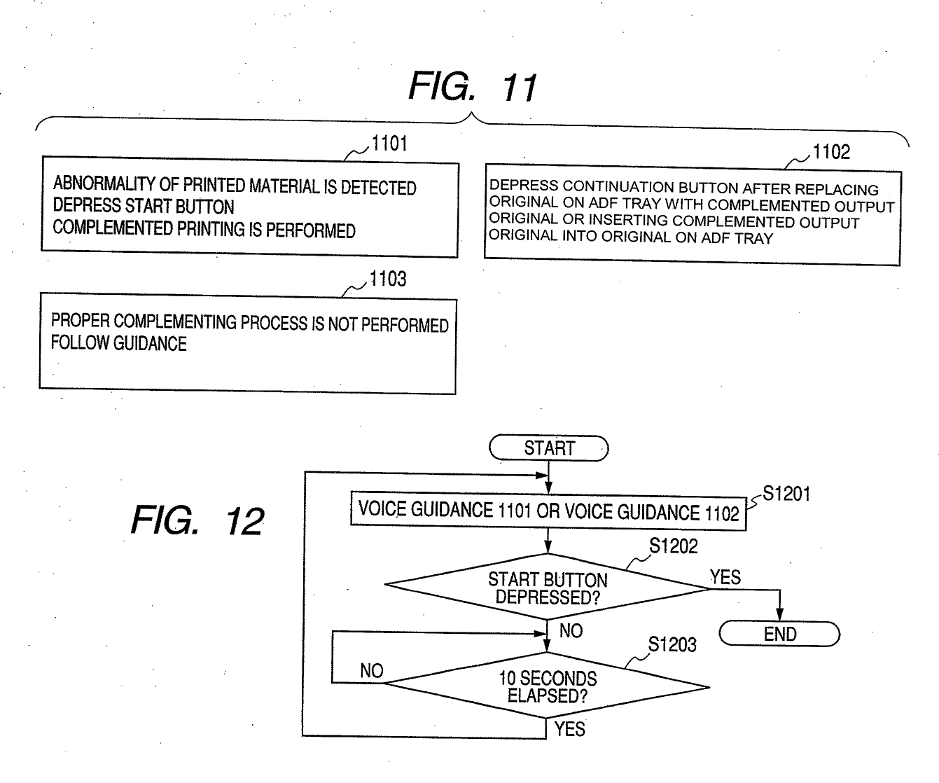

FIG. 11 is a diagram illustrating an example of the voice guidance to be voice-output from a voice output unit provided on the operation panel 38 of the MFP 11 illustrated in FIG. 1. Incidentally, the speaker or the like acting as the voice output unit may be constituted as a part of the operation panel 38 or provided as an independent chip at a position that the user of the MFP 11 can easily listen to the voice guidance.

In FIG. 11, voice guidance 1101, voice guidance 1102 and voice guidance 1103 are respectively output as voices. As described in the later-described flow chart, voice data is read from the ROM and then processed in a voice conversion processing unit under the control of the CPU 32, whereby each voice guidance is actually output as the voice. Incidentally, in consideration of shipping destinations, plural kinds of languages are prepared as language to be voice-output. That is, it is possible to achieve voice guidance in appropriate language by setting it when setting up the print processing device.

For example, the voice guidance 1101 is “ABNORMALITY OF PRINTED MATERIAL IS DETECTED: DEPRESS START BUTTON: COMPLEMENTED PRINTING IS PERFORMED”, and the voice guidance 1102 is “DEPRESS START BUTTON AFTER REPLACING OR INSERTING COMPLEMENTED OUTPUT ORIGINAL WITH OR INTO ORIGINAL ON ADF TRAY”.

Further, for example, the voice guidance 1103 is “PROPER COMPLEMENTING PROCESS IS NOT PERFORMED: FOLLOW GUIDANCE”. Incidentally, it may be controlled to make the voice output level of the voice guidance 1103 slightly higher than that of another voice guidance so as to call user's attention.

Furthermore, before performing the respective processes in the flow chart, a preprocess of storing the image inspection job in the storage device 34 of the MFP 11 is necessary.

Here, it should be noted that, in the preprocess, the client PC 12 designates, through the user interface provided by the printer driver illustrated in FIG. 5, how to output the image inspection job and to store the output as the image inspection job, and then performs the print process. Thus, if the print job is generated, the client PC 12 transmits the generated print job to the MFP 11 through the network 13, and the transmitted print job is stored as the image inspection job in the storage device 34 of the MFP 11.

On the other hand, if the client PC 12 does not yet designate, through the user interface provided by the printer driver illustrated in FIG. 5, how to output the image inspection job and to store the output as the image inspection job, the job which has been transferred and output is not stored in the storage device 34 of the MFP 11 but is discarded.

First, the user of the MFP 11 changes in S601 the mode to the image inspection mode through the operation panel 38, and sets in S602 the printed materials to be image inspected onto the original table of the ADF 40 of the MFP 11. Then, the CPU 32 causes in S603 the scanner unit 36 to start reading the original. Subsequently, the following operation is repeated based on the MFP agent 301 until the CPU 32 determines in S604 that reading of all the originals ends.

In S605, the CPU 32 performs the MFP agent 301 to read and analyze the originals one by one.

Here, as an example of such analysis, a method of detecting abnormality by performing pattern matching between the image data included in the image inspection job stored in the storage device 34 of the MFP 11 and the image data read by the scanner unit 36 on the memory 33 is adopted.

Subsequently, in S606, the CPU 32 determines based on the analyzed result whether the print processing state is good or no good. If the CPU 32 determines that the print processing state is good (that is, no abnormality is detected), the flow returns to the process in S603 to read a next original.

On the other hand, if abnormality of the print processing state such as rumple and/or stain of the original itself, improper printing, page missing, or the like, which occurs as the result of original feeding, is detected in S606, the CPU 32 determines that the print processing state is no good.

Then, the CPU 32 temporarily stops in S607 the original reading operation by the ADF 40, and performs in S608 the process of the voice guidance 1101 onto the operation panel 38 to instruct to perform complemented printing.

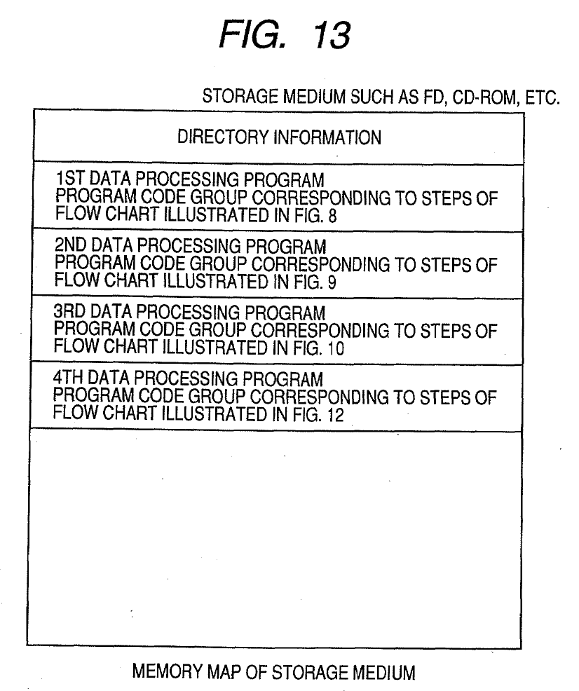

Here, the process of the voice guidance 1101 will be described with reference to a flow chart illustrated in FIG. 12.

FIG. 12 is the flow chart indicating an example of a fourth data processing procedure in the print processing device according to the second embodiment. More specifically, the flow chart in FIG. 12 indicates an example of the image inspection process based on the basic module 302 of the MFP 11 illustrated in FIG. 4 and includes respective steps S1201 to S1203. Here, the CPU 32 loads the basic module 302 from the storage device 34 to the memory 33 and performs the loaded basic module 302, thereby performing the steps S1201 to S1203.

As the process of the voice guidance 1101, the CPU 32 announces in S1201 the voice guidance 1101 illustrated in FIG. 11 to instruct the complemented printing. Then, if it is detected in S1202 that the copy start key 6307 of the operation panel 38 is depressed, the CPU 32 ends the process of the voice guidance and performs a subsequent complemented output process.

On the other hand, if it is detected in S1202 that the copy start key 6307 of the operation panel 38 is not depressed, the flow advances to the process in S1203 to repeatedly announce from the voice output unit the voice guidance 1101 illustrated in FIG. 11 every ten seconds until the copy start key 6307 is depressed.

In the following, the complemented output process according to the present embodiment will be described with reference to FIG. 9.

In the complemented output process according to the present embodiment, the CPU 32 searches in S801 for the relevant page from the image inspection job stored in the storage device 34.

Then, if it is determined in S802 that the search ends, the CPU 32 causes the printer unit 37 to reprint only the relevant page portion, and the process ends.

As just described, if the complemented output process corresponding to S609 ends, the CPU 32 performs in S610 the process of the voice guidance 1102 illustrated in FIG. 11.

Here, the process of the voice guidance 1102 will be described with reference to the flow chart illustrated in FIG. 12.

In the process of the voice guidance 1102, the CPU 32 announces in S1201 the voice guidance 1102 illustrated in FIG. 11 to instruct the complemented printing. Then, if it is detected in S1202 that the copy start key 6307 of the operation panel 38 is depressed, the CPU 32 ends the process of the voice guidance, and the process advances to the process in S611 in FIG. 10.

Then, in S611, it is determined by the CPU 32 whether or not the proper complementing operation (replacement or insertion of the original) has been performed by the user. That is, it is determined whether or not the complemented output original has been removed from the paper discharge tray.

Here, if it is detected in S1202 that the copy start key 6307 of the operation panel 38 is not depressed, the flow advances to the process in S1203 to repeatedly announce from the voice output unit the voice guidance 1102 every ten seconds until the copy start key 6307 is depressed.

On the other hand, if it is detected in S1202 that the copy start key 6307 of the operation panel 38 is depressed, the CPU 32 ends the process illustrated in FIG. 12, and the process advances to the process in S603 in FIG. 10.

That is, in the case where it is detected by the CPU 32 that the copy start key 6307 of the operation panel 38 is depressed, if it is determined that the proper complementing operation (replacement or insertion of the original) has been performed by the user, the CPU 32 restarts in S603 the reading operation to read a next original.

On the other hand, in S611, if it is determined by the CPU 32 that the proper complementing operation is not performed, that is, if the complemented output original is not removed from the paper discharge tray, for example, the voice guidance 1103 illustrated in FIG. 11 acting as a warning announcement is announced once in S612.

Then, the flow returns to S610, and the process of the voice guidance 1102 illustrated in FIG. 11 and the determination in S611 are repeated. Subsequently, the process further returns to the process in S603.

Accordingly, if the user does not end the proper complementing operation, the processes in S610 to S612 illustrated in FIG. 10 are repeated.

By the above procedure, it is possible to acquire the same effect as that in the first embodiment.

### Third Embodiment

In order to achieve the complementing processes in the first and second embodiments, the display of the various messages on the operation panel and the various voice messages may be properly combined with each other.

Moreover, the display of the various messages and the various voice messages may be properly combined with indications by animations on the operation panel.

In the above-described embodiments, if the printed material to be image inspected is a double-sided original, it is determined, at the instant of reading both the sides of the original, whether the printed image is good or no good. Alternatively, the image inspection and complementing system according to the present invention may be achieved by the MFP which is equipped with a scanner capable of one-pass double-sided reading.

Also, the present invention includes a case where the above various devices are operated, according to the programs stored in the CPU 32 of the MFP 11, to achieve the functions of the above-described embodiments.

Incidentally, in the above embodiments, the CPU 32 determines whether the print processing state is good or no good, by comparing the image on the print-processed paper read by the scanner unit 36 with the already-stored image corresponding to the page of the relevant image, and then displays the result of such determination respectively by the different messages.

More specifically, in the case where the print processing state of the image read by the scanner unit 36 is no good, the message 7501 (FIG. 7) is displayed in S408 (FIG. 8) for the paper of which the print processing state is no good. Then, in subsequent S410, in the case where the reprint process to the page corresponding to the image of which the print processing state is no good ends, the message 7502 for requesting the operation enabling to feed the reprint-processed paper from the ADF 40 is displayed.

Further, in the above-described embodiments, the operation request is notified to the user by displaying the message 7502 on the operation panel 38 and by announcing the voice guidance, but how to notify the user of the operation request is not limited to them. That is, it may be configured to display icons or the like as well as the above text messages and voice guidance, to be easily understandable for the user.

### Fourth Embodiment

Hereinafter, the architecture of data processing programs readable by the print processing device according to the present invention will be described with reference to a memory map illustrated in FIG. 13.

FIG. 13 is the diagram for describing the memory map of a storage medium which stores the various data processing programs readable by the print processing device according to the present invention.

Although it is not illustrated specifically, also information (e.g., version information, creator information, etc.) for administrating the program groups stored in the storage medium may occasionally be stored in the storage medium, and information (e.g., icon information for discriminatively displaying a program, etc.) depending on an OS or the like on the program reading side may occasionally be stored in the storage medium.

Moreover, the data depending on the various programs are administrated on the directory of the storage medium. Besides, a program to install various programs into a computer, a program to uncompress installed programs and data when the installed programs and data have been compressed, and the like are occasionally stored.

Furthermore, the functions illustrated in FIGS. 8, 9, 10 and 12 may be performed by a host computer based on externally installed programs. In that case, the present invention is applicable even in a case where an information group including programs is supplied from a storage medium (such as a CD-ROM, a flash memory, an FD or the like) or an external storage medium through a network to an output device.

As described above, it is needless to say that the object of the present invention can be achieved in a case where the storage medium storing the program codes of software to realize the functions of the above embodiments is supplied to a system or an apparatus and then a computer (or CPU or MPU) in the system or the apparatus reads and performs the program codes stored in the storage medium.

In that case, the program codes themselves read from the storage medium realize the new functions of the present invention, whereby the storage medium storing the relevant program codes constitutes the present invention.

Accordingly, because the form of program is no object if it has an actual function as the program, an object code, a program performed by an interpreter, script data supplied to an OS, and the like may be included as the program.

As the storage medium for supplying the program codes, for example, a flexible disk, a hard disk, an optical disk, a magnetooptical (MO) disk, a CR-ROM, a CD-R, a CD-RW, a magnetic tape, a nonvolatile memory card, a ROM, a DVD, or the like can be used.

In that case, the program codes themselves read from the storage medium realize the functions of the above embodiments, whereby the storage medium storing these program codes constitutes the present invention.

Besides, as a method of supplying programs, there is a method of connecting with a website on the Internet by using a browser of a client computer, and downloading the computer program itself of the present invention or a compressed file including an automatic installing function together with the computer program into the recording medium such as a hard disk or the like. Moreover, there is a method of dividing the program codes constituting the program of the present invention into plural files and downloading the respective files from different websites. That is, a WWW server, an ftp (file transfer protocol) server and the like for downloading the program files for achieving the function processes of the present invention with use of the computer to plural operators are included in the scope of the present invention.

Moreover, it is possible to encrypt the program of the present invention, store the encrypted program in a storage medium such as a CD-ROM or the like, distribute the obtained storage media to users, cause the user who has satisfied a predetermined condition to download key information for decrypting the encrypted program from the website through the Internet, cause the relevant user to install the decrypted program into an appropriate computer, and thus achieve the functions of the present invention.

Moreover, it is needless to say that the present invention includes not only a case where the functions of the above embodiments are realized by performing the program codes read by the computer, but also a case where an OS (operating system) or the like functioning on the computer performs a part or the whole of the actual process according to instructions of the program codes, whereby the functions of the above embodiments are achieved by that process.

Moreover, it is needless to say that the functions of the above embodiments can be achieved in a case where the program read from the storage medium is once written in a memory provided in a function expansion board inserted in the computer or a function expansion unit connected to the computer, and then a CPU or the like provided in the function expansion board or the function expansion unit performs a part or the whole of the actual process according to the instructions of the program.

As many apparently widely different embodiments of the present invention can be made without departing from the spirit and scope thereof, it is to be understood that the invention is not limited to the specific embodiments thereof except as defined in the appended claims.

This application claims the benefit of Japanese Patent Application No. 2006-344392, filed Dec. 21, 2006, which is hereby incorporated by reference herein in its entirety.

What is claimed is:

1. A print processing device comprising:
an input unit configured to input a print job including image data of plural pages;
a storage unit configured to store the print job input by the input unit;
a print processing unit configured to perform a print process on plural papers based on the image data of the plural pages included in the print job stored in the storage unit;
an image reading unit configured to acquire the image data for each page by reading the plural papers on which the print process has been performed by the print processing unit;
a determination unit configured to determine whether a print processing state for each page is good or no good, by comparing the image data for each page acquired by the image reading unit with image data corresponding to the acquired image data and stored in the storage unit; and
a control unit configured to control, in a case where it is determined by the determination unit that the print processing state for a specific page is no good, the print processing unit to perform a reprint process based on the image data of the specific page and the image reading unit to stand by for reading of a page subsequent to the specific page until the reprint process by the print processing unit ends.

2. A print processing device according to claim 1, wherein
the image reading unit includes an original feeding unit configured to feed the paper on which the print process has been performed by the print processing unit to a reading position and to discharge the paper on which reading ended to a paper discharge destination, and
the control unit causes the original feeding unit to stand by for feeding of a page subsequent to the specific page to the reading position until the reprint process by the print processing unit ends.

3. A print processing device according to claim 2, further comprising a notification unit configured to notify, in the case where it is determined by the determination unit that the print processing state of the specific page is no good, an operator of the print processing device of a determination result by the determination unit.

4. A print processing device according to claim 3, wherein the notification unit notifies the operator of the print processing device of the determination result so as to cause the operator to put the paper on which the reprinting has been performed on the original feeding unit.

5. A print processing method comprising:
inputting a print job including image data of plural pages;
storing in a storage unit the input print job;
performing a print process on plural papers based on the image data of the plural pages included in the print job stored in the storage unit;
acquiring the image data for each page by reading the plural papers on which the print process has been performed;
determining whether a print processing state for each page is good or no good, by comparing the acquired image data for each page with image data corresponding to the acquired image data and stored in the storage unit; and
controlling, in a case where it is determined that the print processing state for a specific page is no good, to perform a reprint process based on the image data of the specific page and to stand by for reading of a page subsequent to the specific page until the reprint process ends.

6. A print processing method according to claim 5, further comprising feeding the paper on which the print process has been performed to a reading position and discharging the paper on which reading ended to a paper discharge destination, wherein
it is controlled to stand by for feeding of a page subsequent to the specific page until the reprint process ends.

7. A print processing method according to claim 6, further comprising notifying, in the case where it is determined that the print processing state of the specific page is no good, an operator of a print processing device for performing the print processing method of a determined result.

8. A print processing method according to claim 7, wherein the operator of the print processing device for performing the print processing method is notified of the determined result so as to cause the operator to put the paper on which the reprinting has been performed on an original feeding unit.
